(19) United States
(12) Patent Application Publication
(10) Pub. No.: US 2016/0285485 A1
(43) Pub. Date: Sep. 29, 2016

(54) METHOD AND APPARATUS FOR MULTIBAND PREDISTORTION USING TIME-SHARED ADAPTATION LOOP

(71) Applicant: TELEFONAKTIEBOLAGET LM ERICSSON (PUBL), Stockholm (SE)

(72) Inventors: Bilel Fehri, Ottawa (CA); Slim Boumaiza, Waterloo (CA)

(21) Appl. No.: 15/078,801

(22) Filed: Mar. 23, 2016

Related U.S. Application Data
(60) Provisional application No. 62/138,863, filed on Mar. 26, 2015.

(51) Int. Cl. H04B 1/04; H04B 1/62

(52) U.S. Cl. CPC H04B 1/0475; H04B 1/62; H04B 2001/0425

(57) ABSTRACT

Systems and methods for providing multiband predistortion using a time-shared adaptation loop are disclosed. In some embodiments, a multiband predistortion system includes a multiband power amplifier for amplifying N separate bands, a predistortion system including N Digital Predistorters (DPDs), and a single adaptation loop capable of providing predistorter adaptation for the N separate bands. The single adaptation loop includes at least one Training Engine (TE) module where the number of TE modules is less than N, and at least one Transmission Observation Receiver (TOR) module where the number of TOR modules is less than N. In this way, the cost and complexity of the multiband predistortion system can be reduced.

### RELATED APPLICATIONS

This application claims the benefit of provisional patent application Ser. No. 62/138,863, filed Mar. 26, 2015, the disclosure of which is hereby incorporated herein by reference in its entirety.

### TECHNICAL FIELD

The present disclosure relates to multiband predistortion.

### BACKGROUND

In many modern applications, there is a desire for concurrent multi-band transmitters that are capable of transmitting concurrent multi-band signals. As used herein, a concurrent multi-band signal is a signal that occupies multiple distinct frequency bands. More specifically, a concurrent multi-band signal contains frequency components occupying a different continuous bandwidth for each of multiple frequency bands. The concurrent multi-band signal contains no frequency components between adjacent frequency bands. One example of a concurrent multi-band signal is a concurrent dual-band signal. One exemplary application for concurrent multi-band signals that is of particular interest is a multi-standard cellular communications system. A base station in a multi-standard cellular communications system may be required to simultaneously, or concurrently, transmit multiple signals for multiple different cellular communications protocols or standards (i.e., transmit a multi-band signal). Similarly, in some scenarios, a base station in a Long Term Evolution (LTE) cellular communications protocol may be required to simultaneously transmit signals in separate frequency bands.

A concurrent multi-band transmitter includes a multi-band power amplifier that operates to amplify a concurrent multi-band signal to be transmitted to a desired power level. Like their single-band counterparts, multi-band power amplifiers are configured to achieve maximum efficiency, which results in poor linearity. For single-band transmitters, digital predistortion of a digital input signal of the single-band transmitter is typically used to predistort the digital input signal using an inverse model of the nonlinearity of the power amplifier to thereby compensate, or counter-act, the nonlinearity of the power amplifier. By doing so, an overall response of the single-band transmitter is linearized.

In order to determine the compensation to use for the digital predistortion for a single band, a system that includes a transmitter includes a Transmit Observation Receiver (TOR). In operation, a digital transmit signal is predistorted by the digital predistortion subsystem to provide a predistorted transmit signal. The digital predistortion subsystem is adaptively configured to compensate for a nonlinearity of the transmitter and, in particular, a nonlinearity of the PA.

The system includes a feedback path including the TOR that is utilized to adaptively configure the digital predistortion subsystem. The TOR, using an Analog-to-Digital Converter (ADC), samples the downconverted signal at a desired sampling rate to provide a digital TOR output signal. The digital TOR output signal is compared to the transmitted signal to determine an error signal. The digital predistortion subsystem is calibrated based on the error signal. In particular, the digital predistortion subsystem is adaptively configured to minimize, or at least substantially reduce, the error signal.

In multiband predistortion, with N Component Carriers (CC), conventional transmitters require N training engines (TEs), two sets each of N sets of basis functions (one set of N sets of basis functions for the forward path and one set of N sets of basis functions for the adaptation path), and N TORs. This leads to increased complexity and computational resources. As such, improvements are needed for multiband predistortion systems.

### SUMMARY

Systems and methods for providing multiband predistortion using a time-shared adaptation loop are disclosed. In some embodiments, a multiband predistortion system includes a multiband power amplifier for amplifying N separate bands, a predistortion system including N Digital Predistorters (DPDs), and a single adaptation loop capable of providing predistorter adaptation for the N separate bands. The single adaptation loop includes at least one Training Engine (TE) module where the number of TE modules is less than N, and at least one Transmission Observation Receiver (TOR) module where the number of TOR modules is less than N. In this way, the cost and complexity of the multiband predistortion system can be reduced.

In some embodiments, the N separate bands are N Component Carriers (CCs) of a carrier aggregated signal. The single adaptation loop is shared by the N CCs, and the N DPDs are trained selectively as determined by a band selection module. In some embodiments, an order of adaptation of the N DPDs is configurable through the band selection module. In some embodiments, an order of adaptation of the N DPDs is sequential. In some embodiments, an order of adaptation of the N DPDs is based on an Error Vector Magnitude (EVM) performance in each of the N separate bands. In some embodiments, an order of adaptation of the N DPDs is based on an Adjacent Channel Leakage Ratio (ACLR) performance in each of the N separate bands. In some embodiments, an order of adaptation of the N DPDs is based on a Normalized Mean Square Error (NMSE) performance in each of the N separate bands.

In some embodiments, the single adaptation loop also includes a single Basis Function Generator (BFG) module which generates N sets of basis functions for both a forward path of the multiband predistortion system and an adaptation path of the multiband predistortion system. In some embodiments, the single adaptation loop also includes a first BFG module which generates N sets of basis functions for a forward path of the multiband predistortion system and a second BFG module which generates N sets of basis functions for an adaptation path of the multiband predistortion system.

In some embodiments, the single adaptation loop implements an efficient multiband iterative algorithm in the TE module. In some embodiments, the efficient multiband iterative algorithm is a Recursive Least Squares (RLS) algorithm. In some embodiments, the single adaptation loop uses a Model-Reference Adaptive Control (MRAC) learning approach.

In some embodiments, a required amount of feedback information for providing predistorter adaptation for the N separate bands is less than a required amount of feedback information for a multiband predistortion system with N TOR modules. In some embodiments, a required amount of feedback information for providing predistorter adaptation for the N separate bands is less than a required amount of feedback information for a multiband predistortion system with N TE modules.

In some embodiments, N equals two and the multiband predistortion system is a dual-band predistortion system. In some embodiments, the single adaptation loop implements an iterative dual-band estimator in the single TE module. In some embodiments, N is greater than two.

In some embodiments, each band of the N separate bands is a Long Term Evolution (LTE) band. In some embodiments, each band of the N separate bands is a Wideband Code Division Multiple Access (WCDMA) band. In some embodiments, at least two bands of the N separate bands are bands of different Radio Access Technologies (RATs).

Those skilled in the art will appreciate the scope of the present disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a single Transmit Observation Receiver (TOR), single Training Engine (TE) dual-band predistortion architecture according to some embodiments of the present disclosure;

FIG. 2 illustrates a single-TOR, single-TE multiband predistortion architecture according to some embodiments of the present disclosure;

FIG. 3 shows linearization results for a Class F Doherty Power Amplifier (PA) driven by a 101 Wideband Code Division Multiple Access (WCDMA) signal @ 1.8 GHz and a 15 MHz Long Term Evolution (LTE) signal @ 2.1 GHz;

FIG. 4 shows EVM and ACLR results for a Class F Doherty PA driven by a 101 WCDMA signal @ 1.8 GHz and a 15 MHz LTE signal @ 2.1 GHz;

FIG. 5 shows linearization results for a Class F Doherty PA driven by a 1001 WCDMA signal @ 1.96 GHz and a 20 MHz LTE signal @ 2.035 GHz; and

FIG. 6 shows Error Vector Magnitude (EVM) and Adjacent Channel Leakage Ratio (ACLR) results for a Class F Doherty PA driven by a 1001 WCDMA signal @ 1.96 GHz and a 20 MHz LTE signal @ 2.035 GHz.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Real-time predistortion adaptation is performed based on monitoring and capturing Power Amplifier (PA) output in a transmitter observation path. To minimize the PA's output distortion, a Training Engine (TE) compares feedback signals with reference input signals and implements a control algorithm to update Digital Predistorter (DPD) coefficients.

In multiband predistortion, with N Component Carriers (CC), conventional transmitters require N TEs, two sets each of N sets of basis functions (one set of N sets of basis functions for the forward path and one set of N sets of basis functions for the adaptation path), and N Transmit Observation Receivers (TORs). This leads to increased complexity and computational resources. As such, improvements are needed for multiband predistortion systems.

Many prior art attempts use a self-tuning regulator (STR) learning approach. This approach consists of comparing an output signal from the DPD to the output signal from the PA in order to generate a predistorted signal. A fundamental requirement for the STR learning approach is the simultaneous capture of the different component carriers' outputs.

Systems and methods for providing multiband predistortion using a time-shared adaptation loop are disclosed. In some embodiments, a multiband predistortion system includes a multiband power amplifier for amplifying N separate bands, a predistortion system including N DPDs, and a single adaptation loop capable of providing predistorter adaptation for the N separate bands. The single adaptation loop includes at least one TE module where a number of TE modules is less than N, and at least one TOR module where a number of TOR modules is less than N. In this way, the cost and complexity of the multiband predistortion system can be reduced.

In some embodiments, the multiband predistortion system adopts a different learning approach fundamentally avoiding the limitation of STR learning approaches, namely, a Model-Reference Adaptive Control (MRAC) learning approach. MRAC has the advantage of requiring only one component carrier output at a time.

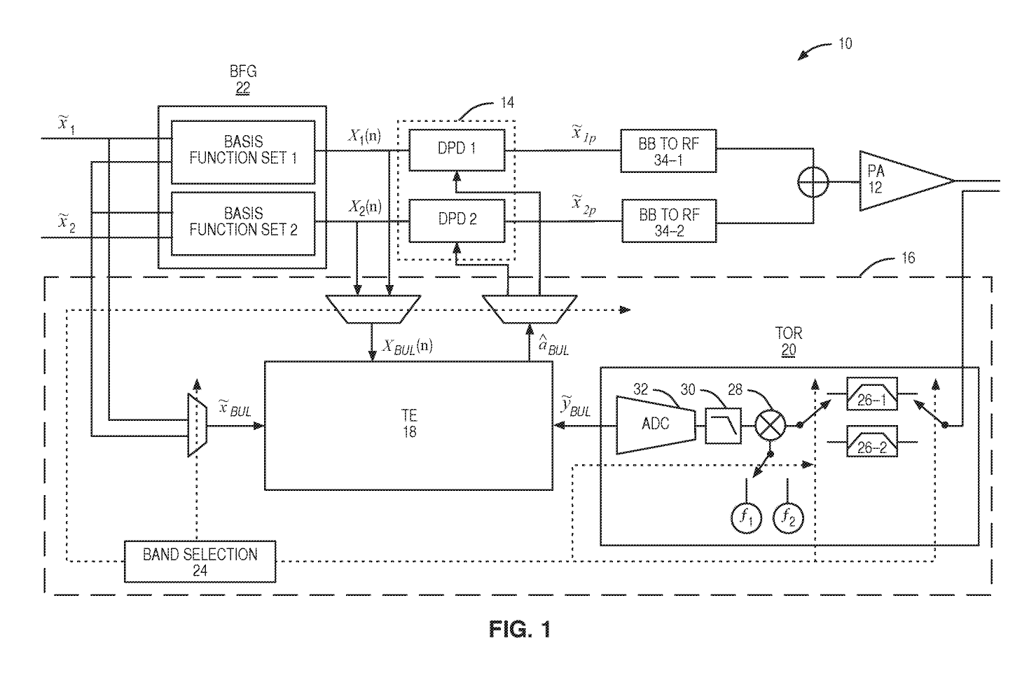

In some embodiments, the MRAC learning approach enables a single-TE, single-Basis Function Generator (BFG), single-TOR adaptation loop architecture effectively time-shared between the different CCs and their respective DPD branches, as shown in FIG. 1.

FIG. 1 illustrates a multiband predistortion system 10 that has N equal to two, that is, the multiband predistortion system 10 is a dual-band predistortion system. The two CC inputs are noted as \tilde{x}₁ and \tilde{x}₂ and their respective pre-distorted signals are noted as \tilde{x}₁ₚ and \tilde{x}₂ₚ. The multiband predistortion system 10 includes a multiband power amplifier 12 for amplifying the two separate bands. Two DPD modules (DPD 1 and DPD 2) are included in predistortion system 14, and there is a DPD for each band. FIG. 1 also shows a single adaptation loop 16 capable of providing predistorter adaptation for the two separate bands.

As shown in FIG. 1, the single adaptation loop 16 includes a TE 18 and a TOR 20. The multiband predistortion system 10 also includes a BFG 22, which in this embodiment generates two sets of basis functions for both a forward path of the multiband predistortion system 10 and for an adaptation path of the multiband predistortion system 10. In other embodiments, there may be a first BFG which generates the set of basis functions for the forward path of the multiband predistortion system 10 and a second BFG which generates the set of basis functions for the adaptation path of the multiband predistortion system 10.

The multiband predistortion system 10 of FIG. 1 also includes a band selection module 24 as discussed in more detail below. In operation, the band selection module 24 determines which band is currently being linearized, which is referred to as the Band Under Linearization (BUL). As shown in FIG. 1, the indication can be communicated to various parts of the multiband predistortion system 10 such as various switches and multiplexers that control which filters or signals are used.

TOR 20 is shown as including two filters 26-1 and 26-2 that correspond to the two separate bands. As shown in FIG. 1, the corresponding filter is selected using the BUL output by the band selection module 24. The signal for the BUL is then downsampled by a mixer 28. The mixer 28 uses a frequency corresponding to the BUL output by the band selection module 24. The signal then passes through a low-pass filter 30 and an Analog-to-Digital Converter (ADC) 32 to provide the digital baseband feedback signal for the BUL shown as \tilde{y}_{BUL}.

The digital outputs of the predistortion system 14 are converted to the correct frequency by upconverters 34-1 and 34-2 before being combined for amplification by the multiband power amplifier 12.

In FIG. 1, the two DPD modules (DPD 1 and DPD 2) in some embodiments execute a dual-band predistortion function to the two input CCs given by:

$${\tilde{x}}_{1 p} ( n ) = {\sum }_{i}^{{N}_{1}} {\sum }_{j}^{{J}_{1}} {\sum }_{m}^{{M}_{1}} {\sum }_{v}^{{V}_{1}} {\hat{a}}_{i , j , m , v}^{1} {ϕ}_{i , j , m , v}^{1} ( {\tilde{x}}_{1} ( n ) , {\tilde{x}}_{2} ( n ) ) = {\hat{a}}^{1} \cdot {X}_{1} ( n )$$

$${\tilde{x}}_{2 p} ( n ) = {\sum }_{i}^{{N}_{2}} {\sum }_{j}^{{J}_{2}} {\sum }_{m}^{{M}_{2}} {\sum }_{v}^{{V}_{2}} {\hat{a}}_{i , j , m , v}^{2} {ϕ}_{i , j , m , v}^{2} ( {\tilde{x}}_{2} ( n ) , {\tilde{x}}_{1} ( n ) ) = {\hat{a}}^{2} \cdot {X}_{2} ( n )$$

where N₁ and J₁ represent the nonlinearity orders of the first CC, N₂ and J₂ represent the nonlinearity orders of the second CC, M₁ and V₁ represent the memory depths of the first CC, and M₂ and V₂ represent the memory depths of the second CC. â_{i,j,m,v}¹, and â_{i,j,m,v}² are the model's coefficients for the first and second CCs, respectively. â¹ is a vector comprising all the coefficients' values of â_{i,j,m,v}¹. â² is a vector comprising all the coefficients' values of â_{i,j,m,v}². φ_{i,j,m,n}¹, and φ_{i,j,m,n}² are the model's sets of basis functions for the first and second CCs, respectively. X₁(n) is a vector comprising all basis function values of φ_{i,j,m,n}¹. X₂(n) is a vector comprising all basis function values of φ_{i,j,m,n}². X₁(n) and X₂(n) are computed in the Basis Function Set 1 and Basis Function Set 2 modules, respectively, as shown in FIG. 1.

Band Selection Module:

This module implements the band selection strategy to control the allocation of the single-TE and single-TOR between the different CCs. In one embodiment, the band selection module 24 can switch alternatingly between the different CCs. In one embodiment, the band selection module 24 can switch based on the Error Vector Magnitude (EVM) performance in each band. In one embodiment, the band selection module 24 can switch based on Adjacent Channel Leakage Ratio (ACLR) performance in each band. In one embodiment, the band selection module 24 can switch based on Normalized Mean Square Error (NMSE) performance in each band.

Single-TE Module:

The TE module 18 is used to train the DPD module of the BUL selected by the band selection module 24. In some embodiments, the TE module 18 implements the algorithm described below. In FIG. \tilde{x}_{BUL} is the input signal envelope of the band under linearization (BUL). It is the band selected by the band select module shown in FIG. 1 to undergo predistortion training in the current iteration, i.e. \tilde{x}_{BUL} will be either \tilde{x}₁ or \tilde{x}₂ depending on the iteration. \tilde{y}_{BUL} is the output signal envelope of BUL provided by the single-TOR module. â_{BUL} is the model's coefficients for the BUL. â_{BUL} could be either â¹ or â² based on the selection of band selection module 24.

Single-TOR Module:

The single-TOR module is used to monitor and capture one CC output envelope signal at a time. The TOR 20 output, ŷ_{BUL}, is connected to the TE module 18. The band selection module 24 configures the TOR 20 (e.g., local oscillators, filters, etc.) to select the appropriate band, the BUL.

Single-BFG Module:

The proposed approach enables the reuse of the sets of basis functions X₁(n) and X₂(n) in both the DPD branch and training branch. Hence, they are computed only in the forward branch and sent to the TE module 18. X_{BUL}(n) is the set of basis functions vector for the BUL. X_{BUL}(n) could be either X₁(n) or X₂(n) based on the selection of the band selection module 24.

In some embodiments, the single-TOR 20, single-TE 18 architecture may be enhanced with design of a robust estimator. Yet the estimator should also be convenient for real-time applications with manageable complexity. In some embodiments, including the examples disclosed herein, a Recursive Least Squares (RLS) algorithm is used.

The coefficient identification process can be made adaptive by setting the RLS algorithm to run iteratively. With each iteration, the algorithm begins with the coefficients identified in the last iteration, âᵢ, then uses newly captured data points to estimate the error in the coefficients, Δa, and finally computes the new coefficient set, âᵢ₊₁ which is related to the old set through the forgetting factor, γ, as shown below:

âᵢ₊₁=âᵢ−γ·Δa

The RLS algorithm for the case of dual-band transmission is shown below.

Algorithm I:

### RLS Algorithm Applied to MRAC Learning Approach—Dual-Band Case:

$$Δ = 1 e 5 ;$$

$$W ( 0 ) = \{ \begin{matrix}[ 1 , 0 , …0 ] ; if q = 0 \\ {\hat{a}}_{BUL} ( q - 1 ) ; if q \neq 0\end{matrix} \}$$

$$P ( 0 ) = Δ \cdot I ;$$

$$for n = 1 \text{:} Q$$

$$G = \frac{P ( n ) \cdot {{X}_{B UL} ( n )}^{t}}{1 + {X}_{BUL} ( n ) \cdot P ( n ) \cdot {{X}_{BUL} ( n )}^{t}} ;$$

$$P ( N + 1 ) = ( I - G \cdot {X}_{BUL} ( n ) ) \cdot P ( n ) ;$$

$$e = {y}_{BUL} ( n ) - {x}_{BUL} ( n ) ;$$

$$W ( n + 1 ) = W ( n ) + G \cdot ( e - {X}_{BUL} ( n ) \cdot W ( n ) ) ;$$

$$end$$

$${\hat{a}}_{BUL} ( q + 1 ) = {\hat{a}}_{BUL} ( q ) - γ \cdot W ( Q + 1 ) ;$$

In operation, the different CCs are distorted simultaneously. However, the single-TOR 20, single-TE 18 architecture observes and trains the different CCs in different time frames. A successful implementation of such architecture is contingent on an efficient band selection strategy that is implemented in the band selection module 24. In the proof of concept of this work, a band alternating approach is implemented and experimentally validated.

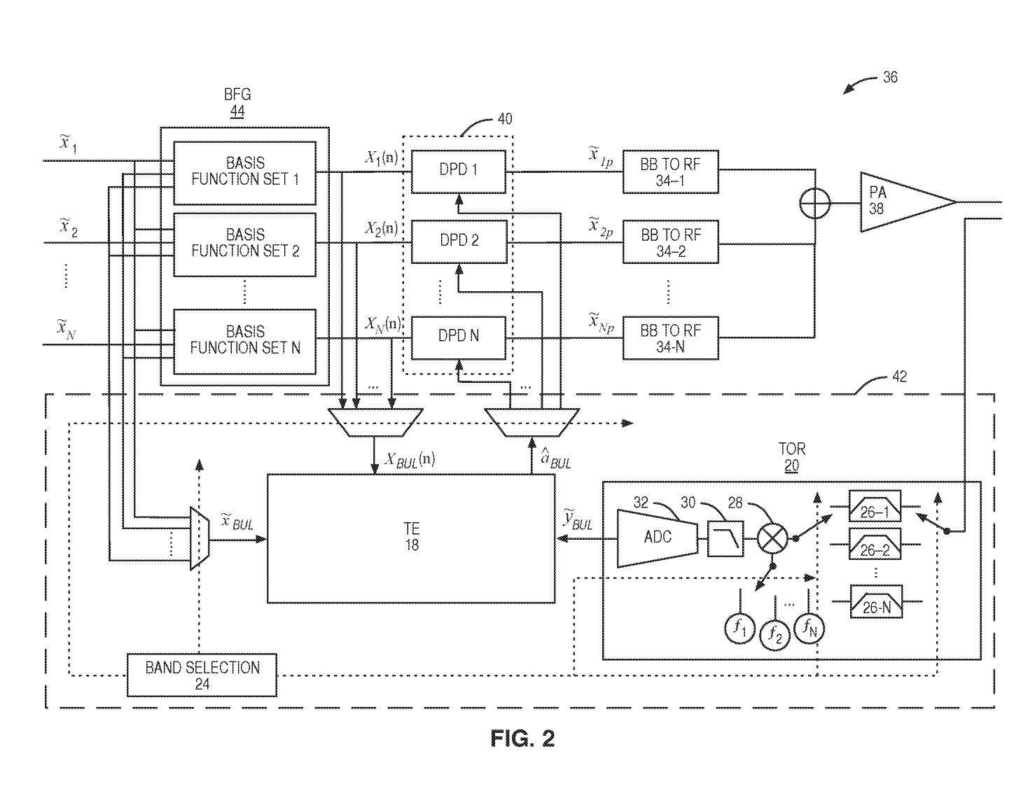

In a multiband case, i.e., with more than two CCs, a multiband predistortion system 36 is shown in FIG. 2. The N inputs are labeled \tilde{x}₁ through \tilde{x}_{N} and their respective pre-distorted signals are labeled \tilde{x}₁ₚ through \tilde{x}_{Np}. The multiband predistortion system 36 includes a multiband power amplifier 38 for amplifying the N separate bands. The N DPD modules (DPD 1 through DPD N) are included in predistortion system 40, and there is a DPD for each band. FIG. 2 also shows a single adaptation loop 42 capable of providing predistorter adaptation for the N separate bands.

As shown in FIG. 2, the single adaptation loop 42 includes a TE 18 and a TOR 20. The multiband predistortion system 36 also includes a BFG 44, which in this embodiment generates two sets each of N sets of basis functions for both a forward path of the multiband predistortion system 36 and for an adaptation path of the multiband predistortion system 36. In other embodiments, there may be a first BFG which generates the set of basis functions for the forward path of the multiband predistortion system 36 and a second BFG which generates the set of basis functions for the adaptation path of the multiband predistortion system 36.

The multiband predistortion system 36 of FIG. 2 also includes a band selection module 24 that operates as discussed above, but with N separate bands. In operation, the band selection module 24 determines which band is the BUL. As shown in FIG. 2, the indication can be communicated to various parts of the multiband predistortion system 36 such as various switches and multiplexers that control which filters or signals are used.

TOR 20 shown in FIG. 2 is similar to the TOR 20 of FIG. 1 but extended to support N separate bands by including N filters 26-1, 26-2, and 26-N that correspond to the N separate bands. As shown in FIG. 2, the corresponding filter is selected using the BUL output by the band selection module 24. The signal for the BUL is then downsampled by the mixer 28. Again, the mixer 28 uses a frequency corresponding to the BUL output by the band selection module 24. The signal then passes through the low-pass filter 30 and the ADC 32 to provide the digital baseband feedback signal for the BUL shown as \tilde{y}_{BUL}.

The digital outputs of the predistortion system 40 are converted to the correct frequency by the upconverters 34-1 through 34-N before being combined for amplification by the multiband power amplifier 38.

In FIG. 2, the N DPD modules (DPD 1 through DPD N) in some embodiments execute a multiband predistortion function to the N input CCs given by

$${\tilde{x}}_{1 p} ( n ) = {\sum }_{i}^{{N}_{1}} {\sum }_{j}^{{J}_{1}} {\sum }_{m}^{{M}_{1}} {\sum }_{v}^{{V}_{1}} {\hat{a}}_{i , j , m , v}^{1} {ϕ}_{i , j , m , v}^{1} ( {\tilde{x}}_{1} ( n ) , {\tilde{x}}_{2} ( n ) , … , {\tilde{x}}_{N} ( n ) ) = {\hat{a}}^{1} \cdot {X}_{1} ( n )$$

$${\tilde{x}}_{2 p} ( n ) = {\sum }_{i}^{{N}_{2}} {\sum }_{j}^{{J}_{2}} {\sum }_{m}^{{M}_{2}} {\sum }_{v}^{{V}_{2}} {\hat{a}}_{i , j , m , v}^{2} {ϕ}_{i , j , m , v}^{2} ( {\tilde{x}}_{2} ( n ) , {\tilde{x}}_{1} ( n ) , … , {\tilde{x}}_{N} ( n ) ) = {\hat{a}}^{2} \cdot {X}_{2} ( n )$$

$${\tilde{x}}_{Np} ( n ) = {\sum }_{i}^{{N}_{N}} {\sum }_{j}^{{J}_{N}} {\sum }_{m}^{{M}_{N}} {\sum }_{v}^{{V}_{N}} {\hat{a}}_{i , j , m , v}^{N} {ϕ}_{i , j , m , v}^{N} ( {\tilde{x}}_{N} ( n ) , {\tilde{x}}_{1} ( n ) , … , {\tilde{x}}_{N - 1} ( n ) ) = {\hat{a}}^{N} \cdot {X}_{N} ( n )$$

where N₁ and J₁ represent the nonlinearity orders of the first CC, N₂ and J₂ represent the nonlinearity orders of the second CC, N_{N} and J_{N} represent the nonlinearity orders of the Nth CC, M₁ and V₁ represent the memory depths of the first CC, M₂ and V₂ represent the memory depths of the second CC, and M_{N} and V_{N} represent the memory depths of the Nth CC. â_{i,j,m,v}¹, â_{i,j,m,v}² and â_{i,j,m,v}^{N} are the model's coefficients for the first, second and Nth CCs, respectively. â₁ is a vector comprising all the coefficients' values of â_{i,j,m,v}¹. â² is a vector comprising all the coefficients' values of â_{i,j,m,v}². â^{N} is a vector comprising all the coefficients' values of â_{i,j,m,v}^{N}. φ_{i,j,m,n}¹; φ_{i,j,m,n}² and φ_{i,j,m,n}^{N} are the model's sets of basis functions for the first, second and Nth CCs, respectively. X₁(n) is a vector comprising all basis function values of φ_{i,j,m,n}¹. X₂(n) is a vector comprising all basis function values of φ_{i,j,m,n}². X_{N}(n) is a vector comprising all basis function values of φ_{i,j,m,n}^{N}. X₁(n), X₂(n), and X_{N}(n) are computed in Basis Function Set 1, Basis Function Set 2, and Basis Function Set N modules, respectively, as shown in FIG. 2.

The RLS algorithm is also extended to the multiband case, as follows:

Algorithm II: RLS Algorithm Applied to MRAC Learning Approach—Dual-Band Case:

$$Δ = 1 e 5 ;$$

$$W ( 0 ) = \{ \begin{matrix}[ 1 , 0 , …0 ] ; if q = 0 \\ {\hat{a}}_{BUL} ( q - 1 ) ; if q \neq 0\end{matrix} \}$$

$$P ( 0 ) = Δ \cdot I ;$$

$$for n = 1 \text{:} Q$$

$$G = \frac{P ( n ) \cdot {{X}_{B UL} ( n )}^{t}}{1 + {X}_{BUL} ( n ) \cdot P ( n ) \cdot {{X}_{BUL} ( n )}^{t}} ;$$

$$P ( N + 1 ) = ( I - G \cdot {X}_{BUL} ( n ) ) \cdot P ( n ) ;$$

$$e = {y}_{BUL} ( n ) - {x}_{BUL} ( n ) ;$$

$$W ( n + 1 ) = W ( n ) + G \cdot ( e - {X}_{BUL} ( n ) \cdot W ( n ) ) ;$$

$$end$$

$${\hat{a}}_{BUL} ( q + 1 ) = {\hat{a}}_{BUL} ( q ) - γ \cdot W ( Q + 1 ) ;$$

In the above algorithm, X_{BUL}(n) is the set of basis functions vector for the BUL. X_{BUL}(n) could be either X₁(n), X₂(n), or X_{N}(n) based on the selection of the band selection module 24.

While the multiband predistortion system 36 shows only a single-TE module 18 and TOR 20, in some embodiments, there may be more than one TE module 18 or TOR 20 as long as the number of TE modules 18 is less than N and the number of TORs 20 is less than N. In such embodiments, one or more band selection modules 24 may control the operation of one or more TE modules 18 and TORs 20. For instance, in an embodiment with five separate bands, the first two bands may be controlled by a first TE module 18 and a first TOR 20 while the remaining three bands are controlled by a second TE module 18 and a second TOR 20.

To assess the performance of the proposed technique, it was used to model and linearize a high power dual-band Radio Frequency (RF) PA. The Device Under Test (DUT) was a 20 Watt class F Doherty PA driven by carrier aggregated signals. The proposed solution was implemented and validated under experimental measurements for dual-band systems.
a. Iterative algorithm choice: an RLS estimator was applied to a MRAC learning approach
b. Band selection strategy: A band-alternating approach was implemented.
c. Results: single-TE single-TOR single-BFG architecture performance matched the conventional performance of 2-TE 2-TOR 2-BFG architecture.

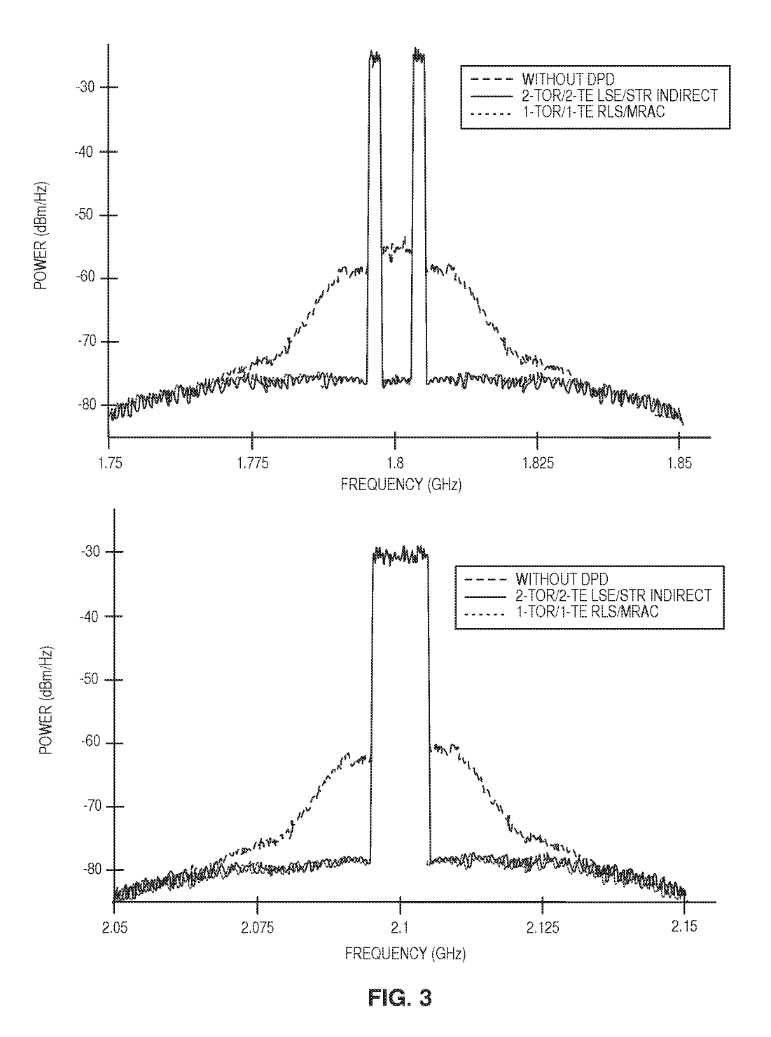

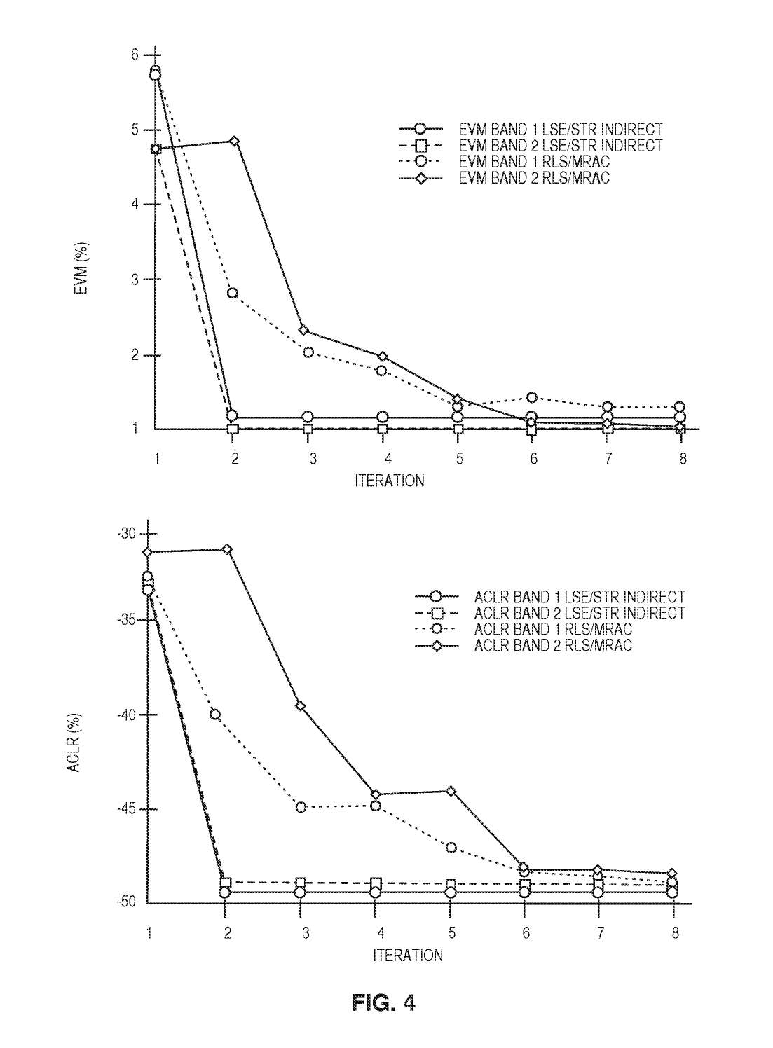

As a first test, an inter-band carrier aggregated signal formed by a 101 Wideband Code Division Multiple Access (WCDMA) signal @ 1.8 GHz and a 15 MHz Long Term Evolution (LTE) signal @ 2.1 GHz was synthesized and fed to the DUT. The resultant signals were subsequently used to feed the dual-band Baseband Equivalent (BBE) Volterra DPD stage. The DPD model's nonlinearity order was set equal to 7, and the memory depth of the different distortion components was set to M₁=3, M_{3,s}=M_{3,d}=1, M_{5,s}=M_{5,d1}=M_{5,d2}=M₇=0. The model was also extended with 5 even powered terms and required 30 coefficients overall. Linearization results are shown in FIG. 3, and the EVM and the ACLR results versus iterations are shown in FIG. 4.

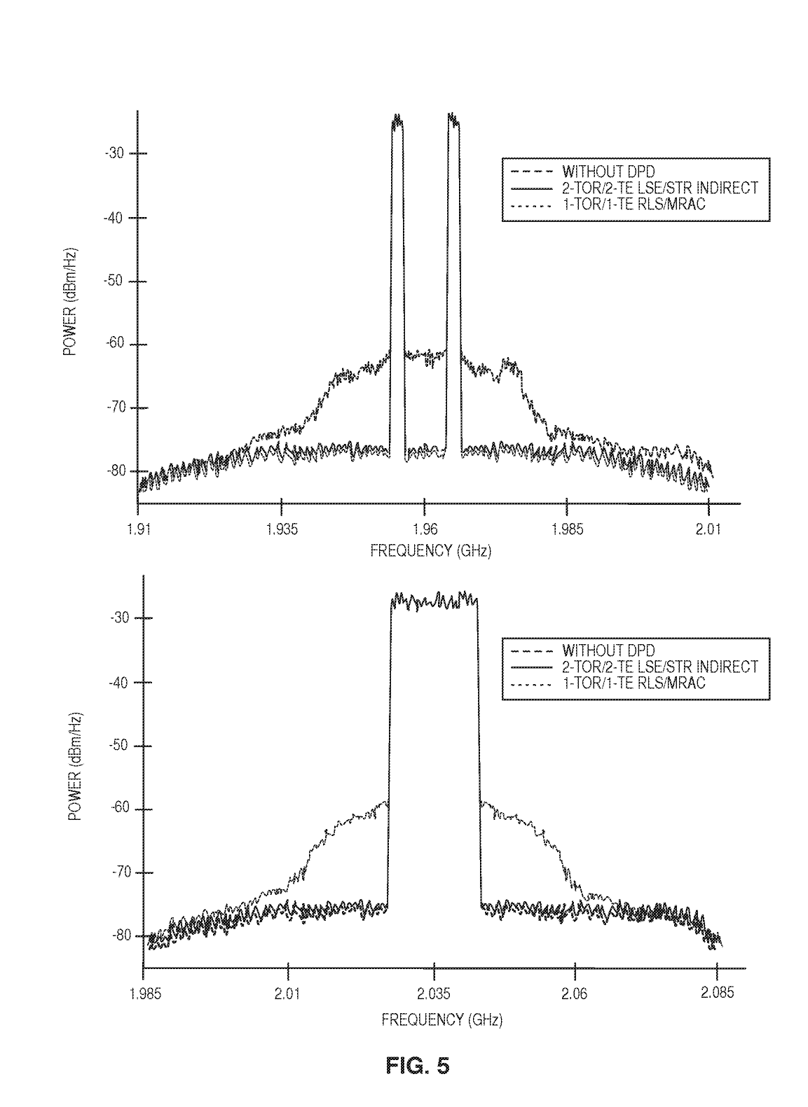

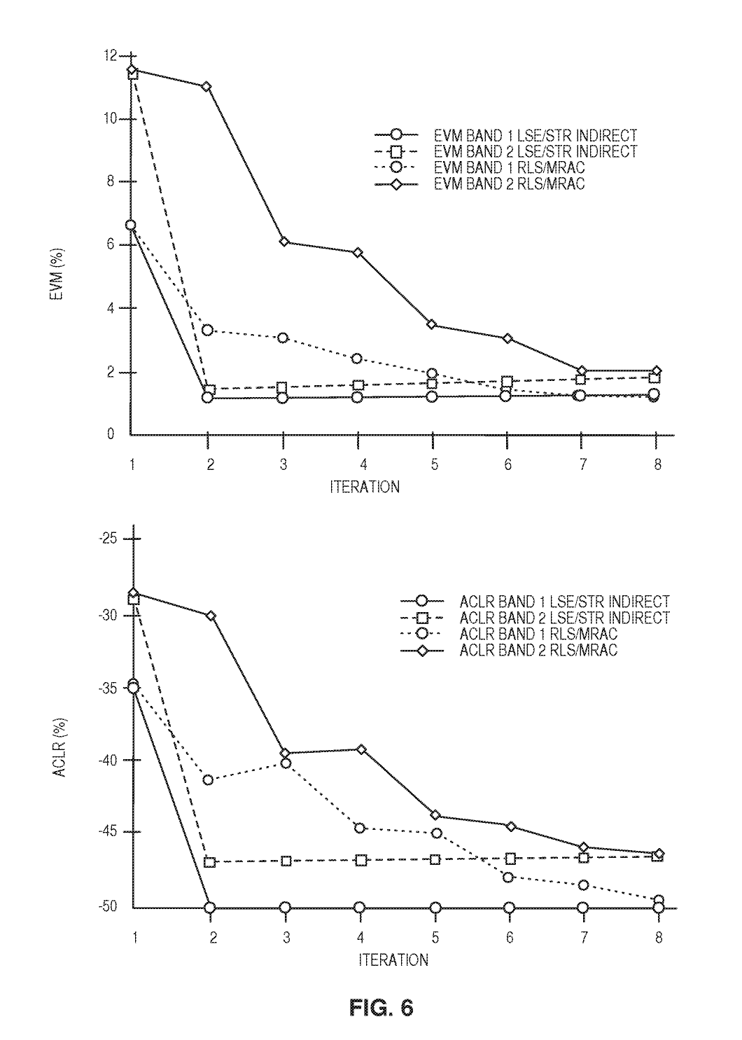

As a second test, an intra-band carrier aggregated signal driven by a 1001 WCDMA signal @ 1.96 GHz, and a 20 MHz LTE signal @ 2.035 GHz was synthesized and fed to the DUT. The same above linearization procedure was applied. Linearization results are shown in FIG. 5, and the EVM and the ACLR results versus iterations are shown in FIG. 6.

For the two measurement cases, the proposed linearization method, i.e., the single-TOR 20 and a single-TE 18 architecture implementing RLS/MRAC learning approach, was compared to the conventional linearization method, i.e., the 2-TOR, 2-TE architecture implementing a Least Square Error (LSE)/STR-indirect learning approach. The two methods showed similar linearization results. Note that the proposed approach used 8 iterations to converge while the conventional one converged with only 2 iterations. However, the RLS algorithm's simpler arithmetic and fast convergence rate when compared to the LSE algorithm balances out the difference in iteration count.

The following acronyms are used throughout this disclosure.
ACLR Adjacent Channel Leakage Ratio
ADC Analog-to-Digital Converter
BBE Baseband Equivalent
BFG Basis Function Generator
BUL Band Under Linearization
CC Component Carrier
DPD Digital Predistorter
DUT Device Under Test
EVM Error Vector Magnitude
LSE Least Square Error
MRAC Model-Reference Adaptive Control
NMSE Normalized Mean Square Error
PA Power Amplifier
RAT Radio Access Technology
RF Radio Frequency
RLS Recursive Least Square
STR Self Tuning Regulator
TE Training Engine
TOR Transmitter Observation Receiver
WCDMA Wideband Code Division Multiple Access

Those skilled in the art will recognize improvements and modifications to the embodiments of the present disclosure. All such improvements and modifications are considered within the scope of the concepts disclosed herein and the claims that follow.

What is claimed is:

1. A multiband predistortion system comprising:
a multiband or broadband power amplifier for amplifying N separate bands;
a predistortion system comprising N Digital Predistorters (DPDs); and
a single adaptation loop capable of providing predistorter adaptation for the N separate bands, comprising:
at least one Training Engine (TE) module, where the number of TE modules is less than N; and
at least one Transmission Observation Receiver (TOR) module, where the number of TOR modules is less than N.

2. The multiband predistortion system of claim 1 wherein:
the N separate bands are N Component Carriers (CCs) of a carrier aggregated signal;
the single adaptation loop is shared by the N CCs; and
the N DPDs are trained selectively as determined by a band selection module.

3. The multiband predistortion system of claim 2 wherein an order of adaptation of the N DPDs is configurable through the band selection module.

4. The multiband predistortion system of claim 2 wherein an order of adaptation of the N DPDs is sequential.

5. The multiband predistortion system of claim 2 wherein an order of adaptation of the N DPDs is based on an error vector magnitude (EVM) performance in each of the N separate bands.

6. The multiband predistortion system of claim 2 wherein an order of adaptation of the N DPDs is based on an adjacent channel leakage ratio (ACLR) performance in each of the N separate bands.

7. The multiband predistortion system of claim 2 wherein an order of adaptation of the N DPDs is based on a normalized mean square error (NMSE) performance in each of the N separate bands.

8. The multiband predistortion system of claim 7 wherein the single adaptation loop further comprises a single Basis Function Generator (BFG) module which generates N sets of basis functions for both a forward path of the multiband predistortion system and an adaptation path of the multiband predistortion system.

9. The multiband predistortion system of claim 7 wherein the single adaptation loop further comprises:
a first Basis Function Generator (BFG) module which generates N sets of basis functions for a forward path of the multiband predistortion system; and
a second BFG module which generates N sets of basis functions for an adaptation path of the multiband predistortion system.

10. The multiband predistortion system of claim 9 wherein the single adaptation loop implements an efficient multiband iterative algorithm in the TE module.

11. The multiband predistortion system of claim 10 wherein the efficient multiband iterative algorithm is a recursive least squares (RLS) algorithm.

12. The multiband predistortion system of claim 11 wherein the single adaptation loop uses a Model-Reference Adaptive Control (MRAC) learning approach.

13. The multiband predistortion system of claim 12 wherein a required amount of feedback information is less than a required amount of feedback information for a multiband predistortion system with N TOR modules.

14. The multiband predistortion system of claim 13 wherein a required amount of feedback information is less than a required amount of feedback information for a multiband predistortion system with N TE modules.

15. The multiband predistortion system of claim 14 wherein N equals two.

16. The multiband predistortion system of claim 15 wherein the single adaptation loop implements an iterative dual-band estimator in the single TE module.

17. The multiband predistortion system of claim 14 wherein N is greater than two.

18. The multiband predistortion system of claim 17 wherein each band of the N separate bands is a Long Term Evolution (LTE) band.

19. The multiband predistortion system of claim 17 wherein each band of the N separate bands is a Wideband Code Division Multiple Access (WCDMA) band.

20. The multiband predistortion system of claim 17 wherein at least two bands of the N separate bands are bands of different Radio Access Technologies (RATs).
